(19) United States
(12) Patent Application Publication
(10) Pub. No.: US 2007/0200013 A1
(43) Pub. Date: Aug. 30, 2007

(54) Shower head that is detached easily and quickly

(76) Inventor: Hu-Ting Hsiao, Shetou Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/520,244

(22) Filed: Sep. 13, 2006

(30) Foreign Application Priority Data
Feb. 27, 2006 (TW) 095203320

(51) Int. Cl. B05B 1/14

(52) U.S. Cl. 239/557; 239/548

(57) ABSTRACT

A shower head includes a housing having a first side formed with a plurality of water outlet holes, a plurality of nozzles each detachably mounted in the respective water outlet hole, a top cover detachably mounted on an open second side of the housing, and a water dividing member detachably mounted on the top cover and connected to the inside of the housing. Thus, the top cover can be detached from the housing to facilitate a user washing the inside of the housing. In addition, each of the nozzles is made of a flexible material, so that each of the nozzles can be deformed to detach from the respective water outlet hole easily and quickly, thereby facilitating the user replacing the nozzles.

### BACKGROUND OF THE INVENTION

1. Field of the Invention

The present invention relates to a shower head and, more particularly, to a shower head used the bathroom or the like.

2. Description of the Related Art

A conventional shower head in accordance with the prior art shown in FIGS. 6-8 comprises a housing 70 having a first side formed with a plurality of water outlet holes 73, a plurality of nozzles 74 each fixed in the respective water outlet hole 73 of the housing 70, a top cover 71 fixed on an open second side of the housing 70 by soldering, and a universal connector 72 mounted on the top cover 71 and connected to the inside of the housing 70.

When in use, the universal connector 72 is mounted on a ceiling (not shown) and has a water inlet channel 720 connected to the water pipe (not shown) of the ceiling and the inside of the housing 70, so that the water from the water pipe of the ceiling is introduced through the water inlet channel 720 of the universal connector 72 into the inside of the housing 70. Then, the water from the inside of the housing 70 is introduced through and injected outwardly from the water outlet holes 73 of the housing 70 and the nozzles 74 for use with a user.

However, the top cover 71 is fixed on the housing 70 by soldering, so that the top cover 71 cannot be detached from the housing 70, thereby causing inconvenience to a user when wastes are deposited in the inside of the housing 70. In addition, each of the nozzles 74 is locked in the respective water outlet hole 73 of the housing 70, so that each of the nozzles 74 cannot be detached from the respective water outlet hole 73 of the housing 70 for replacement. Further, the water from the universal connector 72 into the inside of the housing 70 is concentrated on a central portion of the housing 70 as shown in FIG. 8, so that the water injected outwardly from the water outlet holes 73 of the housing 70 is not distributed evenly and smoothly, thereby decreasing the flushing effect of the shower head, and thereby providing a uncomfortable sensation to the user.

### BRIEF SUMMARY OF THE INVENTION

In accordance with the present invention, there is provided a shower head, comprising a housing having a hollow inside and having a first side formed with a plurality of water outlet holes, a plurality of nozzles each detachably mounted in the respective water outlet hole of the housing, a top cover detachably mounted on an open second side of the housing, and a water dividing member detachably mounted on the top cover and connected to the inside of the housing.

The primary objective of the present invention is to provide a shower head that is detached easily and quickly.

Another objective of the present invention is to provide a shower head, wherein the top cover can be detached from the housing by unscrewing the locking screws to facilitate a user washing and cleaning the inside of the housing, thereby enhancing the lifetime of the shower head.

A further objective of the present invention is to provide a shower head, wherein each of the nozzles is made of a flexible material, so that each of the nozzles can be deformed to detach from the respective water outlet hole of the housing easily and quickly, thereby facilitating the user replacing the nozzles.

A further objective of the present invention is to provide a shower head, wherein the water is introduced by the water dividing holes of the water dividing member, so that the water is distributed into the inside of the housing and is injected outwardly from the water outlet holes of the housing evenly and smoothly, thereby enhancing the flushing effect of the shower head, and thereby providing a comfortable sensation to the user.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a shower head in accordance with the preferred embodiment of the present invention.

FIG. 2 is an exploded perspective view of the shower head as shown in FIG. 1.

FIG. 3 is a partially perspective broken view of a water dividing member of the shower head as shown in FIG. 2.

FIG. 4 is a plan cross-sectional operational view of the shower head as shown in FIG. 1.

FIG. 5 is a plan cross-sectional operational view of the shower head as shown in FIG. 1.

FIG. 6 is a perspective view of a conventional shower head in accordance with the prior art.

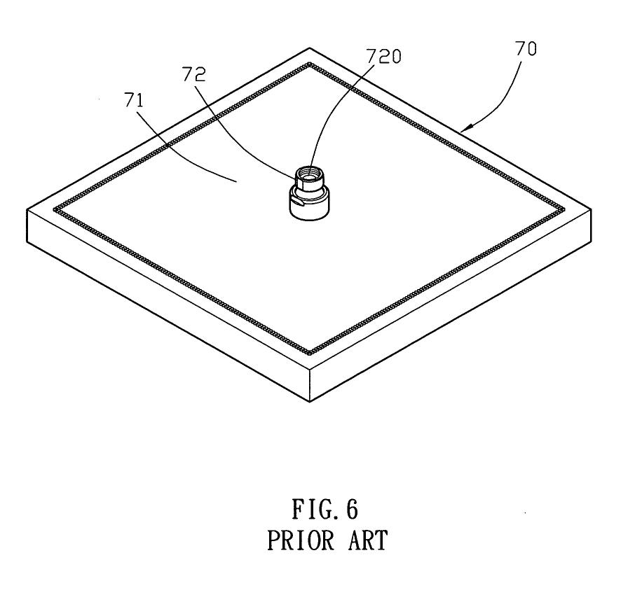

FIG. 7 is a partially exploded perspective view of the conventional shower head as shown in FIG. 6.

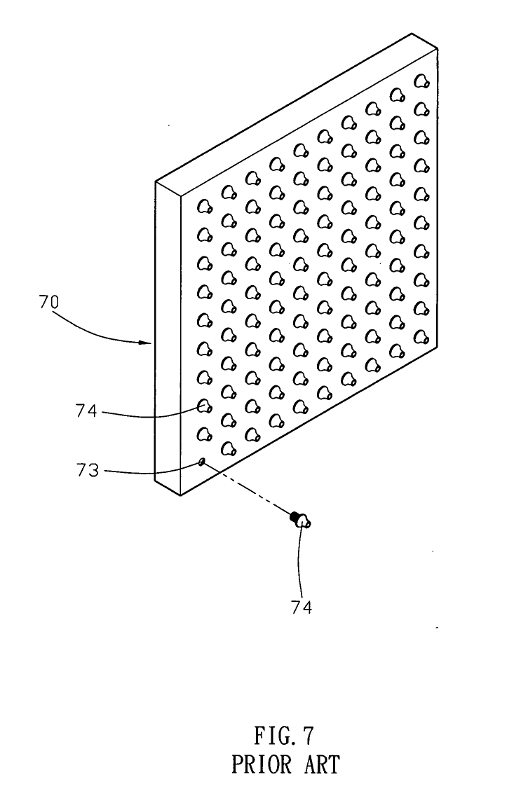

FIG. 8 is a plan cross-sectional operational view of the conventional shower head as shown in FIG. 6.

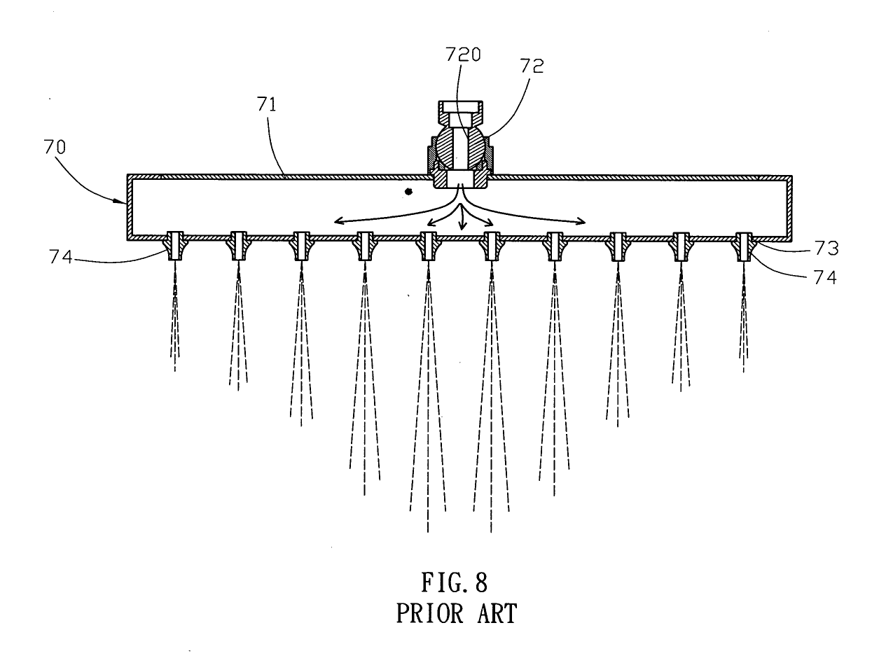

### DETAILED DESCRIPTION OF THE INVENTION

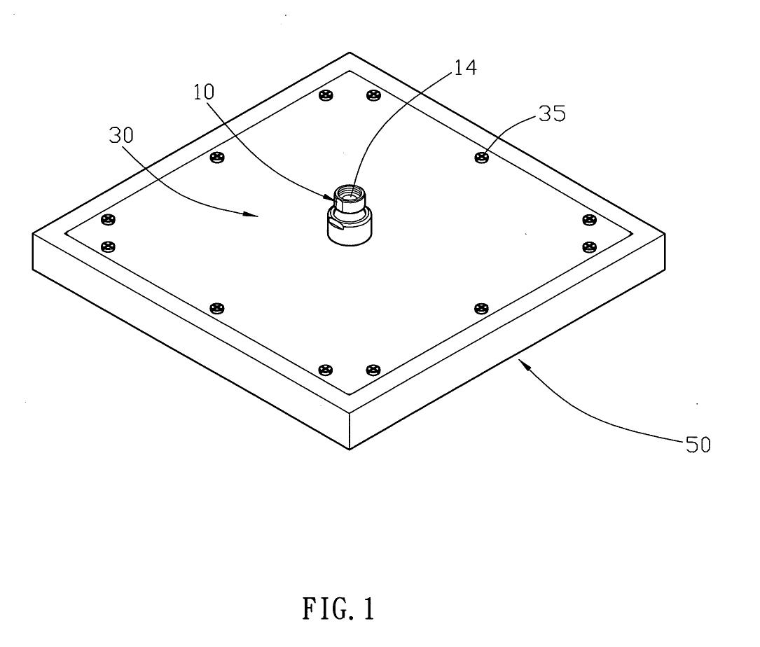

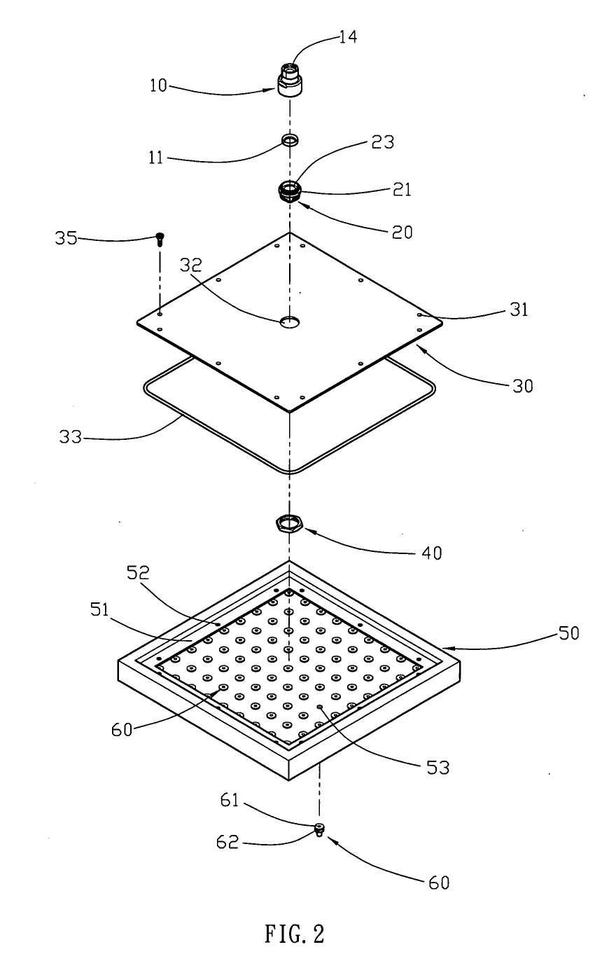

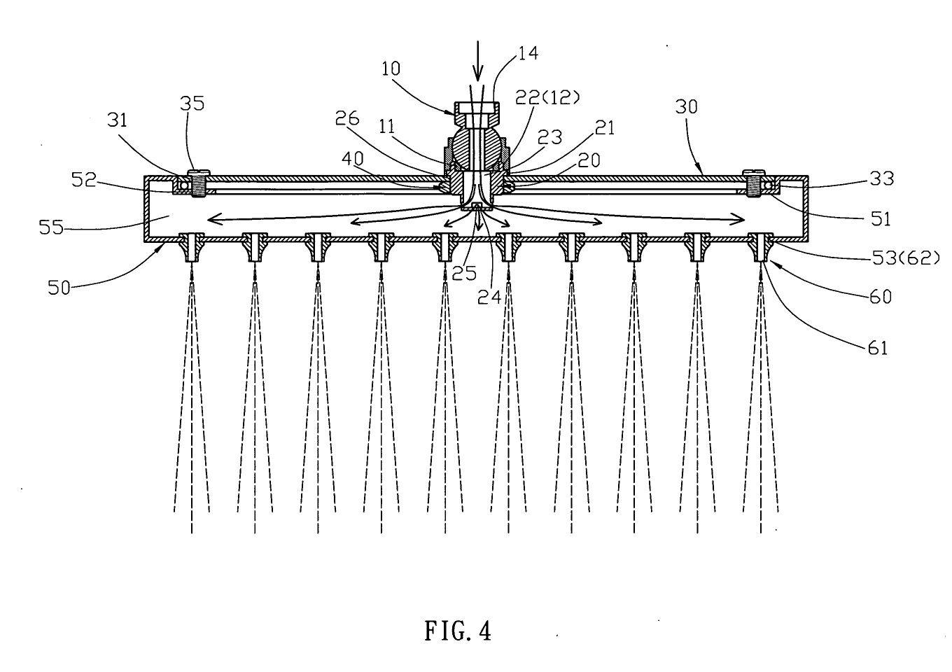

Referring to the drawings and initially to FIGS. 1-4, a shower head in accordance with the preferred embodiment of the present invention comprises a housing 50 having a hollow inside 55 (see FIG. 4) and having a first side formed with a plurality of water outlet holes 53, a plurality of nozzles 60 each detachably mounted in the respective water outlet hole 53 of the housing 50, a top cover 30 detachably mounted on an open second side of the housing 50, a seal member 33 mounted between the top cover 30 and the open second side of the housing 50 to provide a water sealing effect, a water dividing member 20 detachably mounted on the top cover 30 and connected to the inside 55 of the housing 50, a universal connector 10 detachably mounted on and connected to the water dividing member 20, and a gasket 11 mounted between the universal connector 10 and the water dividing member 20.

The open second side of the housing 50 is provided with an inwardly extending support flange 51 having a stepped shape to support the top cover 30. The support flange 51 of the housing 50 has a periphery formed with a plurality of screw bores 52.

The top cover 30 has a central portion formed with a passage 32 to allow passage of the water dividing member 20 and has a periphery formed with a plurality of through holes 31 aligning with the screw bores 52 of the support flange 51 of the housing 50.

The shower head further comprises a plurality of locking screws 35 each extended through the respective through hole 31 of the top cover 30 and each screwed into the respective screw bore 52 of the support flange 51 of the housing 50 to attach the top cover 30 onto the support flange 51 of the housing 50.

The seal member 33 is mounted between the top cover 30 and the support flange 51 of the housing 50 and retained by the locking screws 35.

The water dividing member 20 has an inside formed with a water flow channel 23 having a stepped shape. The water dividing member 20 has a first portion extended through the top cover 30 into the inside 55 of the housing 50 and a second portion protruded outwardly from the top cover 30. The water dividing member 20 has a mediate portion having a periphery formed with an outwardly extending annular stop flange 21 protruded outwardly from the top cover 30 and rested on a top of the top cover 30. The stop flange 21 is located between the first portion and the second portion of the water dividing member 20. The first portion of the water dividing member 20 is formed with a protrusion 24 having a closed wall and having a periphery formed with a plurality of water dividing holes 25 each connected to the water flow channel 23 and the inside 55 of the housing 50. The water dividing holes 25 of the water dividing member 20 are equally spaced from each other in an angular manner. The first portion of the water dividing member 20 is formed with an outer thread 26, and a locking nut 40 is screwed onto the outer thread 26 of the first portion of the water dividing member 20 and rested on a bottom of the top cover 30 to attach the water dividing member 20 onto the top cover 30. The second portion of the water dividing member 20 is formed with an outer thread 22.

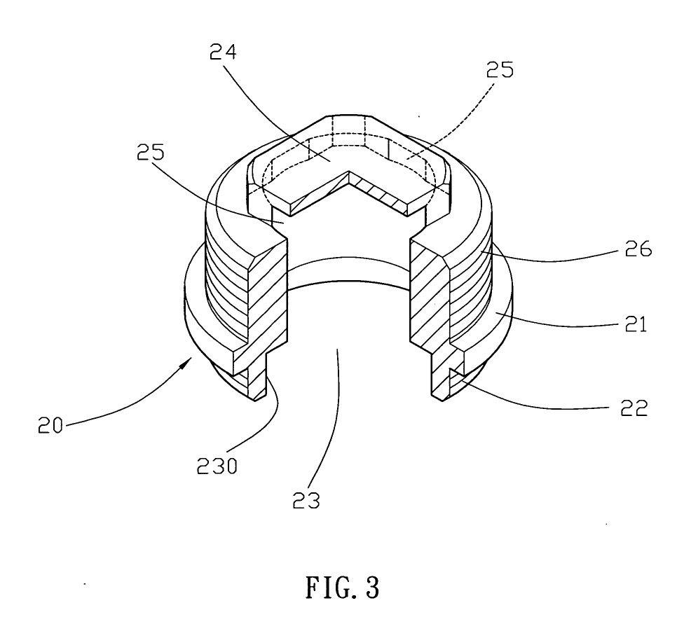

The gasket 11 is received in a stepped portion 230 (see FIG. 3) of the water flow channel 23 of the water dividing member 20.

The universal connector 10 has an inside formed with a water inlet channel 14 connected to a water pipe (not shown) and the water flow channel 23 of the water dividing member 20. The universal connector 10 has an end portion formed with an inner thread 12 (see FIG. 4) screwed onto the outer thread 22 of the second portion of the water dividing member 20 to attach the universal connector 10 onto the water dividing member 20.

Each of the nozzles 60 is made of a flexible material, such as silicon gel, rubber and the like. Each of the nozzles 60 has a first portion detachably inserted into the respective water outlet hole 53 of the housing 50 and a second portion protruded outwardly from the respective water outlet hole 53 of the housing 50. The first portion of each of the nozzles 60 is formed with an annular locking groove 62 locked onto a peripheral wall of the respective water outlet hole 53 of the housing 50. Each of the nozzles 60 has an inside formed with a spraying hole 61 connected to the inside 55 of the housing 50.

When in use, again referring to FIGS. 1-4, the universal connector 10 is mounted on a ceiling (not shown), and the water inlet channel 14 of the universal connector 10 is connected to the water pipe of the ceiling and the water flow channel 23 of the water dividing member 20, so that the water from the water pipe of the ceiling is introduced through the water inlet channel 14 of the universal connector 10 into the water flow channel 23 of the water dividing member 20. Then, the water from the water flow channel 23 of the water dividing member 20 is stopped by the protrusion 24 of the water dividing member 20 so that the water is forced to flow through the water dividing holes 25 of the water dividing member 20 into the inside 55 of the housing 50. Finally, the water from the inside 55 of the housing 50 is introduced through and injected outwardly from the water outlet holes 53 of the housing 50 and the spraying holes 61 of the nozzles 60 for use with a user.

In such a manner, the water is introduced by the water dividing holes 25 of the water dividing member 20, so that the water is distributed into the inside 55 of the housing 50 evenly and smoothly and is injected outwardly from the water outlet holes 53 of the housing 50 evenly and smoothly, thereby enhancing the flushing effect of the shower head, and thereby providing a comfortable sensation to the user.

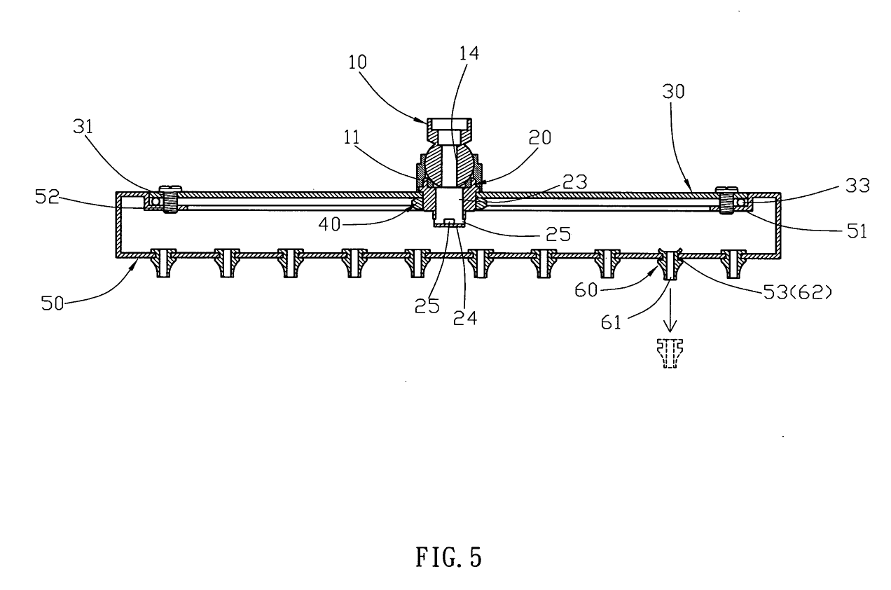

As shown in FIG. 5, each of the nozzles 60 is made of a flexible material, so that each of the nozzles 60 can be deformed to detach from the respective water outlet hole 53 of the housing 50 easily and quickly.

Accordingly, the top cover 30 can be detached from the housing 50 by unscrewing the locking screws 35 to facilitate a user washing and cleaning the inside 55 of the housing 50, thereby enhancing the lifetime of the shower head. In addition, each of the nozzles 60 is made of a flexible material, so that each of the nozzles 60 can be deformed to detach from the respective water outlet hole 53 of the housing 50 easily and quickly, thereby facilitating the user replacing the nozzles 60. Further, the water is introduced by the water dividing holes 25 of the water dividing member 20, so that the water is distributed into the inside 55 of the housing 50 and is injected outwardly from the water outlet holes 53 of the housing 50 evenly and smoothly, thereby enhancing the flushing effect of the shower head, and thereby providing a comfortable sensation to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A shower head, comprising:
a housing having a hollow inside and having a first side formed with a plurality of water outlet holes;
a plurality of nozzles each detachably mounted in the respective water outlet hole of the housing;
a top cover detachably mounted on an open second side of the housing;
a water dividing member detachably mounted on the top cover and connected to the inside of the housing.

2. The shower head in accordance with claim 1, wherein the open second side of the housing is provided with an inwardly extending support flange to support the top cover.

3. The shower head in accordance with claim 2, wherein the support flange of the housing has a periphery formed with a plurality of screw bores, the top cover has a periphery formed with a plurality of through holes aligning with the screw bores of the support flange of the housing, and the shower head further comprises a plurality of locking screws each extended through the respective through hole of the top cover and each screwed into the respective screw bore of the support flange of the housing to attach the top cover onto the support flange of the housing.

4. The shower head in accordance with claim 2, wherein the support flange of the housing has a stepped shape.

5. The shower head in accordance with claim 1, wherein the top cover has a central portion formed with a passage to allow passage of the water dividing member.

6. The shower head in accordance with claim 1, wherein the water dividing member has an inside formed with a water flow channel.

7. The shower head in accordance with claim 6, wherein the water flow channel of the water dividing member has a stepped shape.

8. The shower head in accordance with claim 6, wherein the water dividing member has a first portion extended through the top cover into the inside of the housing and a second portion protruded outwardly from the top cover.

9. The shower head in accordance with claim 8, wherein the first portion of the water dividing member is formed with a protrusion having a closed wall and having a periphery formed with a plurality of water dividing holes each connected to the water flow channel and the inside of the housing.

10. The shower head in accordance with claim 9, wherein the water dividing holes of the water dividing member are equally spaced from each other in an angular manner.

11. The shower head in accordance with claim 8, wherein the first portion of the water dividing member is formed with an outer thread, and the shower head further comprises a locking nut screwed onto the outer thread of the first portion of the water dividing member and rested on a bottom of the top cover to attach the water dividing member onto the top cover.

12. The shower head in accordance with claim 11, wherein the water dividing member has a mediate portion having a periphery formed with an outwardly extending annular stop flange protruded outwardly from the top cover and rested on a top of the top cover.

13. The shower head in accordance with claim 12, wherein the stop flange is located between the first portion and the second portion of the water dividing member.

14. The shower head in accordance with claim 1, wherein each of the nozzles is made of a flexible material, such as silicon gel.

15. The shower head in accordance with claim 1, wherein each of the nozzles has a first portion detachably inserted into the respective water outlet hole of the housing and a second portion protruded outwardly from the respective water outlet hole of the housing.

16. The shower head in accordance with claim 1, wherein each of the nozzles has an inside formed with a spraying hole connected to the inside of the housing.

17. The shower head in accordance with claim 1, wherein the first portion of each of the nozzles is formed with an annular locking groove locked onto a peripheral wall of the respective water outlet hole of the housing.

18. The shower head in accordance with claim 8, wherein the second portion of the water dividing member is formed with an outer thread, and the shower head further comprises a universal connector detachably mounted on and connected to the water dividing member, wherein the universal connector has an inside formed with a water inlet channel connected to the water flow channel of the water dividing member and has an end portion formed with an inner thread screwed onto the outer thread of the second portion of the water dividing member to attach the universal connector onto the water dividing member.

19. The shower head in accordance with claim 3, further comprising a seal member mounted between the top cover and the open second side of the housing to provide a water sealing effect, wherein the seal member is mounted between the top cover and the support flange of the housing and retained by the locking screws.

20. The shower head in accordance with claim 18, further comprising a gasket mounted between the universal connector and the water dividing member, wherein the gasket is received in a stepped portion of the water flow channel of the water dividing member.
